(19) United States
(12) Patent Application Publication
(10) Pub. No.: US 2004/0100093 A1
(43) Pub. Date: May 27, 2004

(54) Co-extruded tube with molded connector

(76) Inventor: Keith V. Leigh-Monstevens, Rochester Hills, MI (US)

Correspondence Address: Thomas N. Young, Young & Basile, P.C., 3001 West Big Beaver Road, Suite 624, Troy, MI, 48084, US

(21) Appl. No.: 10/300,974

(22) Filed: Nov. 21, 2002

(51) Int. Cl. F16L 41/00

(52) U.S. Cl. 285/222; 285/293.1

(57) ABSTRACT

A method and apparatus for forming a tube and connector assembly. The tube is formed in a co-extrusion process to provide a multi-ply tube and the multi-ply tube is thereafter delivered to an injection die assembly where a connector is molded onto the end of the tube. The molded on connector provides a ready and efficient means of providing a connector for the tube and further encapsulates the tube end so as to preclude separation of the plies of the tube even in a heavy duty usage environment. The connector may comprise a coaxial connector in which the central axis of the connector is coaxial with the central axis of the tube end portion over which it is molded or may comprise a right angle connector in which the central axis of the connector is at a right angle to the central axis of the tube end portion over which it is molded.

### BACKGROUND OF THE INVENTION

This invention relates to tubes and connectors and more particularly to a method and apparatus for forming a tube and connector assembly.

Tubing is extensively used in automotive applications. In a typical automotive application, the tube exterior is subjected to different damaging elements than the tube interior. For example, the tube exterior is typically exposed to sodium chloride (winter road salt), calcium chloride (summer wet road treatment), and zinc chloride (from adjacent ferrous automotive elements that have been dipped in zinc). By contrast, the tube interior is subjected to the chemistry of the substance being transmitted through the tube, for example the chemistry of polyglycol brake fluid.

In an effort to address this exterior/interior chemical damage disparity, compromise materials have been proposed in an effort to partially satisfy the peculiar concerns of exterior and interior. However, this comprise solution does not totally satisfy either need. In a further effort to address this chemical damage disparity, co-extruded tubes have been proposed so that each ply of the tube may be customized to address the peculiar needs of that ply. However, the plies of co-extruded tubes have tended to separate in usage, particularly proximate the ends of the tubes.

### SUMMARY OF THE INVENTION

This invention is directed to the provision of an improved tube and connector assembly.

According to a feature of the invention, a method is provided for forming a tube and connector assembly comprising forming a tube in a co-extruding operation and forming a connector on one end of the co-extruded tube in a molding operation. The molded on connector precludes separation of the plies of the co-extruded tube even in heavy duty applications and the formation of the connector on the end of the tube in a molding operation provides a quick and efficient means of providing the connector.

In one embodiment of the invention, the connector includes a bore coaxial with the tube bore and in another embodiment the connector includes a bore disposed at a right angle to the tube bore.

According to a further feature of the invention, an apparatus is provided for forming a tube and connector assembly comprising a co-extrusion die assembly operative to form a multi-ply tube and an injection die assembly operative to receive one end of the multi-ply tube and mold a connector onto the received end of the tube. This arrangement provides a ready and efficient means of forming a multi-ply tube with a molded on connector.

According to a further feature of the invention, the injection die assembly defines a cavity, a first bore opening in the cavity and sized to receive the tube end, and a second bore opening in the cavity; and the injection die assembly further includes an axial core slidably received in the second bore and having a free inboard end projecting into the cavity and positionable adjacent the free inboard end of the tube end received in the first bore. This arrangement provides a ready and efficient means for molding the connector onto the tube end.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a schematic view showing the basic methodology of the invention whereby a multi-ply tube is formed and a connector is molded onto an end of the multi-ply tube;

FIGS. 1A and 1B illustrate alternate connector and tube assemblies formable by the invention methodology;

FIG. 2 illustrates an injection die assembly for use in forming a connector that is coaxial with the central tube axis;

FIG. 3 illustrates an injection die assembly for use in forming a connector that is disposed at a right angle to the central tube axis;

FIG. 4 is a cross-sectional view of a coaxial tube and connector assembly;

FIG. 5 is a cross-sectional view of a right angle tube and connector assembly; and

FIG. 6 is a cross-sectional view taken on line 6-6 of FIGS. 4/5.

### DESCRIPTION OF THE PREFERRED EMBODIMENT

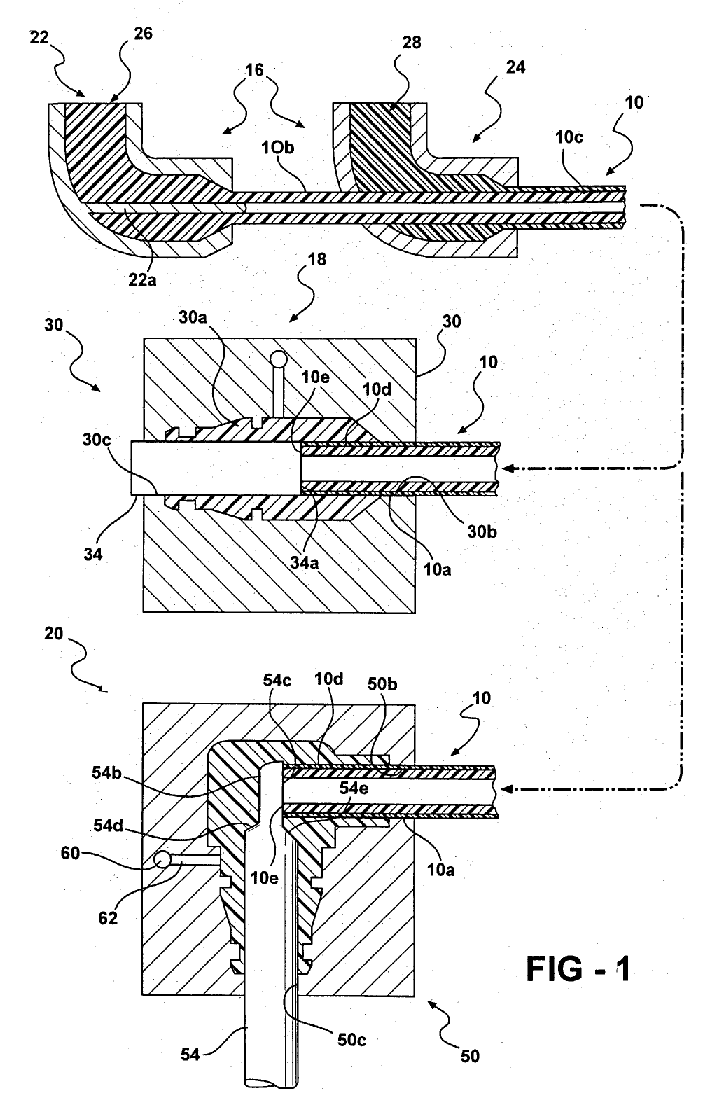

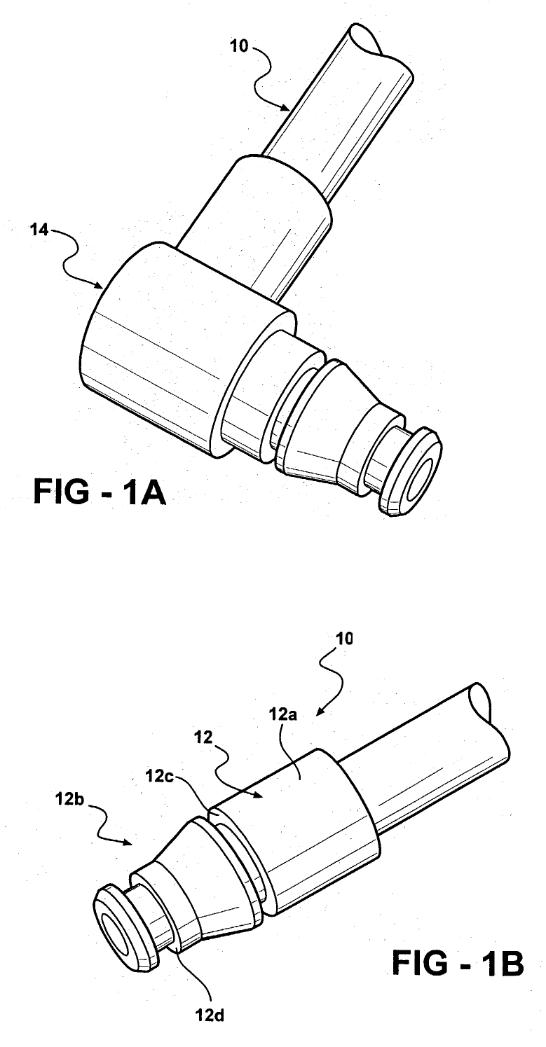

As seen in FIG. 1, a connector is formed on the end of a tube 10 in a co-extrusion and injection molding operation. The connector may either comprise a coaxial connector 12 formed coaxially with respect to the central tube axis, as seen in FIG. 1A, or may comprise a right angle connector 14 formed at a right angle with respect to the central tube axis, as seen in FIG. 1B. In the formation of the tube and coaxial connector assembly, a co-extrusion die assembly 16 is employed to form the multi-ply tube 10 and a coaxial injection die assembly 18 is employed to mold the coaxial connector 12 onto the end 10a of the tube. In the formation of the tube and right angle connector assembly, co-extrusion die assembly 16 is employed to form the multi-ply tube 10 and a right angle injection die assembly 20 is employed to mold the right angle connector 14 onto the end 10a of the tube.

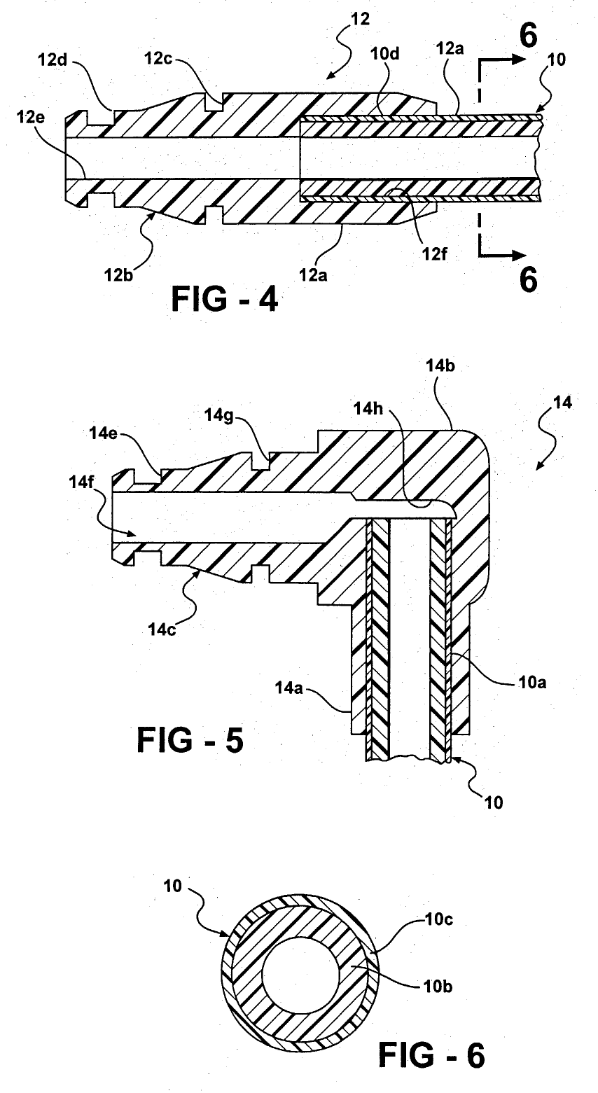

With additional reference to FIGS. 1A and 4, coaxial connector 12 includes a tubular portion 12a telescopically positioned over the tube end portion 10a, and a fitting portion 12b. It will be understood that fitting portion 12b is arranged to fit telescopically within a port defined in an apparatus to which it is desired to deliver fluid through the tube 10 and, in known manner, includes a groove 12c for receipt of an O-ring and a further groove 12d for receipt of a suitable clip whereby to fixedly secure the fitting portion 10b to the apparatus defining the port. A central, axially extending bore 12e is defined in fitting portion 12b and a counter bore 12f is defined in tubular portion 12a.

With reference to FIGS. 1B and 5, right angle connector 14 includes a tubular portion 14a telescopically positioned over tube end portion 10a, a main body portion 14b, and a fitting portion 14c extending at a right angle to tubular portion 10a. It will be understood that fitting portion 14c is arranged to fit telescopically within a port defined in an apparatus to which it is desired to deliver fluid through the tube 10 and, in known manner, includes a groove 14d for receipt of an O-ring and a further groove 14e for receipt of a suitable clip whereby to fixedly secure the fitting portion 14c to the apparatus defining the port. A central axially extending bore 14f is defined in fitting portion 14c and in main body portion 14b. Bore 14f includes a main body portion 14g and a reduced diameter, relatively flat portion 14h positioned in overlying relation to the open end of tube end portion 10a. The central axis of bore 14f will be seen to be disposed at a right angle to the central axis of the tube 10 so that the connector 14 forms a right angle connector with respect to the tube 10.

The manner in which the tube 10 and coaxial connector 12 assembly is formed is seen in FIG. 1 with reference to co-extrusion die assembly 16 and coaxial injection die assembly 18. Specifically, an inner tube ply or layer 10b is formed by a first extrusion die 22 of known form and employing a central core 22a in known manner, an outer tube ply or layer 10c is formed over inner ply 10b by a second extrusion die 24. The molten material 26 that is forced under pressure through extrusion die 20 to form inner ply 10b may comprise, for example, a Nylon 66 material and the molten material 28 that is forced under pressure through extrusion die 24 in surrounding relation to inner ply 10b may comprise, for example, a Nylon 12 material. For a tube having an outside diameter of 8.00 mm., outer ply 10c may have a thickness of 0.50 mm. and inner ply 10b may have a thickness of 1.50 mm.

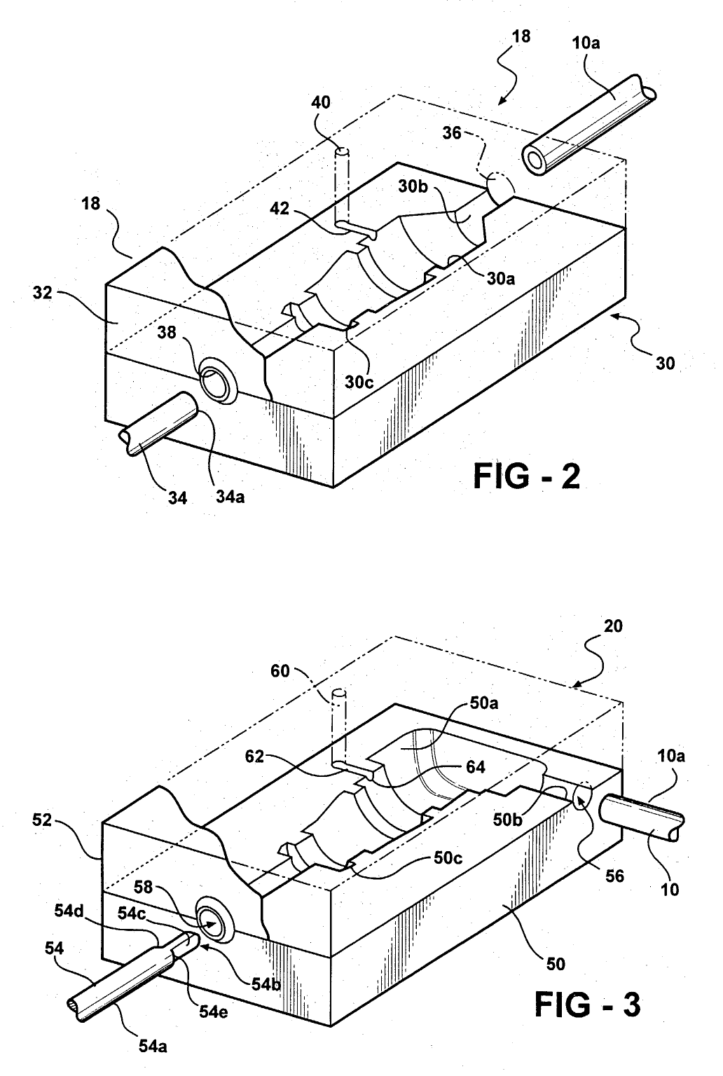

Following the formation of the multi-ply tube 10 in the extrusion die assembly 16, the tube is allowed to set and is then suitably transferred to injection die assembly 18 (see also FIG. 2).

Injection die assembly 18 includes a lower die or mold half 30, an upper die or mold half 32, and an axial core 34. Lower die 30 defines a lower half 30a of a mold cavity, a semicircular lower groove 30b sized to receive tube end 10a, and a semicircular lower groove half 30c sized to receive axial core 34. It will be understood that upper die 32 defines a complimentary upper half of the mold cavity and complimentary upper groove halves coacting with the mold cavity 30a and the semicircular grooves 30b and 30c to form the total mold cavity, a cylindrical bore 36 for slidable receipt of tube end portion 10a, and a cylindrical bore 38 for slidable receipt of axial core 34.

Die assembly 18, in known manner, further includes a sprue 40, a runner 42 extending from the lower end of the sprue to the mold cavity, and a gate 44 at the entry of the runner into the mold cavity. Axial core 34 has a cylindrical configuration including a circular inboard end face 34a.

In the use of the die assembly 18 to form the connector 12 on the tube end portion 10a; tube end portion 10a is positioned in the groove 30b of the lower die to position the inboard end 10d of the tube end portion in the mold cavity; axial core 34 is positioned in groove 34c with inboard end face 34a abutting the annular inboard end face 10e of the inboard tube end; upper die 32 is positioned over the lower die;

molten plastic material (such for example as Nylon 12 or Nylon 612 glass reinforced) is supplied to sprue 40 for passage through runner 42 and through gate 44 into the mold cavity to fill the mold cavity in surrounding relation to the inboard tube end 10d and the axial core; and, following setting of the plastic material, the upper die is removed from the lower die and the axial core 34 is removed. This molding procedure forms a connector 12 fixedly secured to the tube end portion 10d and having an axial bore 12b communicating with the open end of the tube. The tube end portion 10d will be seen to occupy the counter bore 12f of the connector.

The manner in which the tube 10 and right angle connector 14 assembly is formed is seen in FIG. 1 with reference to co-extrusion die assembly 16 and right angle injection die assembly 20. The multi-ply tube, including inner ply 10b and co-extruded outer ply 10c, is formed in the same manner, of the same materials, and of the same ply thicknesses, as described with respect to the formation of the tube 10 and coaxial connector 12 assembly.

Following the formation of the multi-ply tube 10 in the extrusion die assembly 16, the tubing is allowed to set and is then suitably transferred to injection mold assembly 20 (see also FIG. 3). Injection mold assembly 20 includes a lower die or mold half 50, an upper die or mold half 52, and an axial core 54. The lower die 50 defines a lower half 50a of a mold cavity, a semicircular lower groove half 50b sized to receive tube 10, and a semicircular lower groove half 50c sized to receive axial core 54. It will be understood that upper die 52 defines a complimentary upper half of the mold cavity and complimentary upper groove halves coacting with the mold cavity 50a and the semicircular grooves 50b and 50c to form the total mold cavity, a cylindrical bore 56 for slidable receipt of tube end portion 10a, and a cylindrical bore 58 for slidable receipt of axial core 54.

The die assembly, in known manner, further includes a sprue 60, a runner 62 extending from the lower end of the screw to the mold cavity, and a gate 64 at the entry of the runner 62 into the mold cavity.

Axial core 54 includes a cylindrical main body portion 54a slidably received in bore 50c and a flat inboard end portion 54b defining a flat sealing surface 54c and connected to the main body portion 54a by chamferred surfaces 54d and 54e.

In the use of die assembly 20 to form the connector 14 on the tube end portion 10a, a tube end portion 10a is positioned in the groove 50b of the lower die 50 to position the inboard end 10d of the tube in the mold cavity; axial core 54 is positioned in the groove 50c with end portion 54b overlying the open end of the tube and sealing surface 54c sealingly engaging the annular end face 10e of the tube; the upper die 52 is positioned over the lower die; molten plastic material (such for example as Nylon 12 or Nylon 612 glass reinforced) is supplied to sprue 60 for passage through runner 62 and through gate 64 into the mold cavity to fill the mold cavity in surrounding relation to the tube end 10d and the axial core; and, following setting of the plastic materia, the upper die is removed from the lower die and the axial core 54 is removed. This molding procedure forms a connector 14 fixedly secured to the tube end portion 10d and having an axial bore 14f communicating with the open end of the tube, extending at a right angle to the central axis of the tube end portion, and conforming to the configuration of the core.

The invention will be seen to provide a method and apparatus for molding a connector over the end of a multi-ply tube whereby to prevent separation of the tube plies and allow the customization of each layer of the tube to the peculiar requirements of each layer. Specifically, the outer ply may be formed of a low moisture absorption material that resists the chemical attacks peculiar to the automotive/road environment and the inner ply may be formed of a material that is stronger and has a higher melting point, whereby to accommodate the pressures and temperatures of the fluid flowing through the tube.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method of forming a tube and connector assembly comprising:
forming a tube in a co-extruding operation; and
forming a connector on one end of the co-extruded tube in a molding operation.

2. A method according to claim 1 wherein the central axis of the connector is coaxial with the central axis of the tube.

3. A method according to claim 1 wherein the central axis of the connector is disposed at a right angle with respect to the central axis of the tube.

4. A tube and connector assembly comprising:
a tube having a multi-ply construction; and
a connector molded onto an end of the tube.

5. A tube and connector assembly according to claim 4 wherein the connector includes a bore coaxial with the tube bore.

6. A tube and connector assembly according to claim 4 wherein the connector includes a bore disposed at a right angle with respect to the tube bore.

7. A tube and connector assembly comprising:
a multi-ply tube formed in a co-extrusion operation; and
a connector formed on an end of the tube in an injection molding operation.

8. A tube and connector assembly according to claim 7 wherein the connector includes a bore coaxial with the tube bore.

9. A tube and connector assembly according to claim 7 wherein the connector includes a bore disposed at a right angle with respect to the tube bore.

10. An apparatus for forming a tube and connector assembly comprising:
a co-extrusion die assembly operative to form a multi-ply tube; and
an injection die assembly operative to receive one end of the multi-ply tube and mold a connector onto the received end of the tube.

11. An apparatus according to claim 10 wherein:
the injection die assembly defines a cavity, a first bore opening in the cavity and sized to receive the tube end, and a second bore opening in the cavity; and
the injection die assembly further includes an axial core slidably received in the second bore and having a free inboard end projecting into the cavity and positionable adjacent the free inboard end of the tube end received in the first bore.

12. An apparatus according to claim 11 wherein:
the first and second bores are coaxial;
the axial core is coaxial with the received tube end; and
the connector includes a central bore coaxial with the tube bore.

13. An apparatus according to claim 11 wherein:
the first bore extends at a right angle with respect to the second bore so that the axial core extends at a right angle with respect to the tube end; and
the connector includes a central bore disposed at a right angle with respect to the tube bore.
